(19) United States
(12) Patent Application Publication
(10) Pub. No.: US 2025/0198832 A1
(43) Pub. Date: Jun. 19, 2025

(54) Distributed Acoustic Sensing Based on Two-Dimensional Waveguides

(71) Applicant: X Development LLC, Mountain View, CA (US)

(72) Inventors: Alex S. Miller, Cambridge, MA (US); Martin Horst Karrenbach, Brea, CA (US); Artem Goncharuk, Mountain View, CA (US); Marina Andrea Dolivo, San Jose, CA (US); Brenton Edward Piercy, San Francisco, CA (US)

(21) Appl. No.: 18/977,381

(22) Filed: Dec. 11, 2024

Related U.S. Application Data
(60) Provisional application No. 63/609,722, filed on Dec. 13, 2023.

(51) Int. Cl. G01H 9/00; G01D 5/353; G02B 6/125; G02B 6/13

(52) U.S. Cl. CPC G01H 9/004; G01D 5/35358; G02B 6/125; G02B 6/13

(57) ABSTRACT

The present disclosure generally relates to systems, software, and computer-implemented methods for distributed acoustic sensing (DAS). One example system includes a two-dimensional (2D) waveguide, including a 2D substrate and a waveguide embedded in the 2D substrate, the waveguide configured to backscatter optical signals, and a first optical sensing system. The first optical sensing system can be configured to transmit a first optical signal into the 2D waveguide, receive a backscattered optical signal generated based on backscattering the first optical signal by the 2D waveguide, and generate a sensing result based on the backscattered optical signal.

### CROSS-REFERENCE TO RELATED APPLICATIONS

This application claims priority to U.S. Application Ser. No. 63/609,722, filed Dec. 13, 2023, the contents of which are incorporated herein by reference in their entirety.

### TECHNICAL FIELD

This disclosure generally relates to distributed acoustic sensing techniques and provides systems, computer-implemented methods, and software for adding capability to distributed acoustic sensing using two-dimensional waveguides.

### BACKGROUND

Distributed Acoustic Sensing (DAS) is a technology that converts a fiber-optic cable into an array of individual acoustic sensors. By transmitting a laser pulse through the fiber-optic cable and measuring the backscattered and/or Rayleigh scattered light, DAS systems can detect the vibrations caused by sound waves or physical disturbances along the length of the fiber-optic cable. These disturbances can include acoustic signals, seismic waves, or even ground movement caused by passing vehicles or people. DAS is currently used in a variety of applications including monitoring CO₂ sequestration sites, pipeline and infrastructure monitoring, and security.

### SUMMARY

The present disclosure generally relates to systems, software, and computer-implemented methods for implementing distributed acoustic sensing using two-dimensional (2D) waveguides.

DAS is typically employed in a linear setting to detect acoustic events along the length of a fiber-optic cable. However, in some cases, a linear fiber-optic cable can be used to implement measurements over a 2D plane. This involves manually laying out the linear fiber-optic cable in a specific pattern, which can lead to inaccuracies in determining the position of the acoustic event on the 2D plane due to imprecise cable layouts. To address this issue, the techniques described here enable the fabrication of a 2D waveguide that can accurately sense a 2D plane. In some implementations, the techniques described herein involve embedding a one-dimensional (1D) linear waveguide in a 2D substrate with a high level of precision. In some implementations, a single 2D waveguide can be fabricated with multiple optical sensing systems employed to coordinate the sensing. The optical sensing system can receive backscattered optical signals and/or signals directly sent from other optical sensing system(s) to generate a sensing result.

A first example system for distributed acoustic sensing DAS includes a 2D waveguide and a first optical sensing system. The 2D waveguide is configured to backscatter optical signals. The first optical sensing system is configured to transmit a first optical signal into the 2D waveguide, receive a backscattered optical signal generated based on backscattering the first optical signal by the 2D waveguide, and generate a sensing result based on the backscattered optical signal.

Implementations can optionally include one or more of the following features.

In some implementations, the 2D waveguide comprises a 2D substrate and a waveguide embedded in the 2D substrate.

In some implementations, the waveguide comprises a plurality of parallel nested paths.

In some implementations, the waveguide comprises a segment having a first end and a second end opposite to the first end, the waveguide bends at the first end, and a first interval at the first end is wider than a second interval at the second end.

In some implementations, the 2D waveguide is fabricated based on at least one of bonding the waveguide to the 2D substrate using a machine; printing the waveguide on the 2D substrate using a three-dimensional printer; a planar light wave circuit (PLC) fabrication method; or a lithium niobate on insulator (LNOI) method.

In some implementations, the 2D substrate comprises a water-permeable membrane or a waterproof plastic layer.

In some implementations, the first example system comprises a fiber-optic cable and an additional 2D waveguide perpendicular to the 2D waveguide, and wherein the fiber-optic cable is used to sense strains on a first axis, the 2D waveguide is used to sense strains on a second axis perpendicular to the first axis, and the additional 2D waveguide is used to sense strains on a third axis perpendicular to the first axis and the second axis.

In some implementations, the first example system comprises a fiber-optic cable and an additional 2D waveguide overlapped with the 2D waveguide, and wherein the fiber-optic cable is used to sense strains on a first axis, the 2D waveguide is used to sense strains on a second axis perpendicular to the first axis, and the additional 2D waveguide is used to sense strains on a third axis perpendicular to the first axis and the second axis.

In some implementations, the first optical sensing system is connected to a fiber-optic cable, and the system comprises a coupler feeding the first optical signal from the fiber-optic cable to the 2D waveguide.

In some implementations, the first example system comprises a second optical sensing system, the second optical sensing system transmits a second optical signal into the 2D waveguide, and the sensing result is generated based on the backscattered optical signal and the second optical signal.

In some implementations, the sensing result indicates at least one of whether an acoustic event has occurred, an amplitude of the acoustic event, a location of the acoustic event, a distance of the acoustic event relative to the first optical sensing system, or a spatial resolution of the distance of the acoustic event.

Similar operations and processes associated with each example system can be performed in different methods. Further, a non-transitory computer-readable medium storing instructions which, when executed, cause at least one processor to perform the operations can also be contemplated. Additionally, similar operations can be associated with or provided as computer-implemented software embodied on tangible, non-transitory media that processes and transforms the respective data, some or all of the aspects can be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram of a system for implementing DAS using 2D waveguides.

FIG. 2 depicts an example 2D waveguide.

FIG. 3 depicts another example 2D waveguide.

FIG. 4 depicts an example system for using 2D waveguides to yield a 3-axis sensing mode.

FIG. 5A and FIG. 5B depict another example system for using 2D waveguides to

FIG. 6 depicts yet another example system for using 2D waveguides to yield a 3-axis sensing mode.

FIG. 7 is a block diagram of a system for implementing DAS using 2D waveguides.

FIG. 8 is a flow diagram of an example method for implementing DAS using 2D waveguides.

### DETAILED DESCRIPTION

DAS can be used to detect acoustic events such as acoustic and/or vibrational disturbances along the length of a fiber-optic cable. In some instances, optical equipment, such as a DAS interrogator, can launch an optical signal (e.g., a laser pulse, a coherent optical signal, etc.) into the fiber-optic cable. The optical signal can be backscattered by reflector(s), including random imperfections, inside the optical fiber. When an acoustic event occurs along the length of the optical fiber, the acoustic field of the acoustic event can change the position(s) of the reflector(s) in the fiber-optic cable, resulting in a phase difference between the optical signal and the backscattered optical signal. By analyzing the phase differences, DAS can be used to measure the amplitude, frequency, and direction of acoustic waves at different locations along the fiber-optic cable, including, for example, the magnitude and/or location of the acoustic event(s). The acoustic event(s) could include seismic waves or ground movement caused by human activity, for example.

While DAS is typically implemented in a linear setting (e.g., along the length of a fiber-optic cable), in some cases, a linear fiber-optic cable can be employed to implement measurements over a 2D plane (e.g., identifying a position of an acoustic event in the 2D plane). This typically involves manually laying out the linear fiber-optic cable in a particular pattern (e.g., a grid pattern) over the 2D plane. In this way, the linear position of the acoustic event along the fiber-optic cable can be determined, and the position of the acoustic event on the 2D plane can be determined based on the linear position. However, this approach can be prone to inaccuracies. In particular, it is challenging to determine the exact layout of the cable if it is laid manually. For example, due to inaccuracies inherent in manual deployments, the actual layout of the cable can be different from what was intended. Accordingly, although the linear position along the fiber-optic cable can be determined, the position of the acoustic event cannot be accurately determined due to the imprecise or imperfect cable layout. The inaccuracies can accumulate when the cable length increases.

The techniques described herein enable the fabrication of a 2D waveguide similar to the shape of a sheet and application of the 2D waveguide to the sensing of a 2D plane. In some implementations, a 1D linear waveguide (e.g., a fiber-optic cable) can be embedded (e.g., bonded, printed, etched, woven, etc.) in a 2D substrate (e.g., a water-permeable membrane, a waterproof plastic layer, etc.) with a high level of precision to fabricate the 2D waveguide. The 1D linear waveguide can be arranged precisely in any desired pattern (e.g., snake-like pattern, grid pattern, spiral pattern, etc.) embedded in the 2D substrate. Because the fiber-optic cables can be laid out precisely in the substrate by using a machine, the techniques can enhance the accuracy compared to laying out the fiber-optic cables by hand.

In some implementations, instead of embedding a 1D linear waveguide in a 2D substrate, a single 2D waveguide can be fabricated. In such implementations, an optical sensing system, such as a DAS interrogator, can generate an optical signal, and a coupler (e.g., an edge coupler, a Bragg coupler, etc.) can transmit the optical signal from the optical sensing system to the 2D waveguide. In some cases, a plurality of optical sensing systems (and correspondingly, a plurality of couplers) can be employed with the 2D waveguide. The plurality of optical sensing systems can send direct signals to each other to coordinate the sensing. Therefore, in addition to the backscattered optical signal, an optical sensing system can also receive optical signals directly sent from each other optical sensing system, and the optical sensing system and/or a DAS analysis system can generate a sensing result based on the backscattered optical signal and the optical signal(s) sent from other optical sensing system(s).

The techniques described herein can be used in the context of implementing DAS using 2D waveguides. In some cases, the techniques described herein can be used with using 2D waveguides to monitor water reservoirs. In such implementations, a 2D waveguide (e.g., a 2D DAS membrane) can be incorporated into a plastic sealing membrane (reservoir). This can enable, for example, leak detection, accounting for rain water, and water volume detection.

In some cases, the techniques described herein can be used with using 2D waveguides to monitor CO₂, in particular for under top soil. For example, the 2D waveguide can be a large (e.g., at least 100 square meters) non-toxic water-permeable membrane placed around the injection site. The 2D waveguide can provide a 2D understanding of induced seismicity and subsidence.

In some cases, the techniques described herein can be used with using 2D waveguides to monitor building foundations. In such implementations, the 2D waveguide can be a sealing layer included in a building foundation. This sealing layer can sense, for example, the movement of the building, subsidence of ground beneath the building, etc. In some cases, the 2D waveguide can be wrapped around other materials, like pipes. The 2D waveguide can be used to see 2D and three-dimensional (3D) wave effects in pipes, detect sources of strain on pipes, etc.

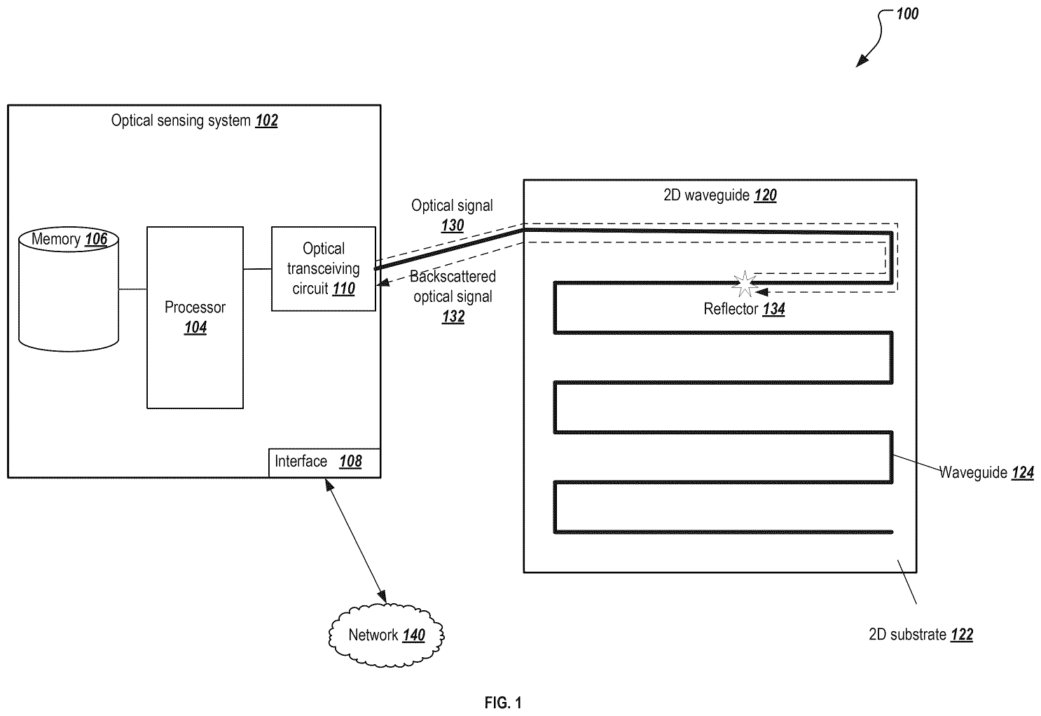

FIG. 1 is a block diagram of a system 100 for implementing DAS using 2D waveguides. As shown in FIG. 1, the example system 100 includes an optical sensing system 102, a 2D waveguide 120, and a network 140.

In some implementations, the optical sensing system 102 can transmit an optical signal 130 into the 2D waveguide 120. The optical signal 130 can travel in the waveguide 124 of the 2D waveguide 120 and can be backscattered by one or more reflectors 134 in the waveguide 124 to generate a backscattered optical signal 132. The backscattered optical signal 132 can be received and analyzed by the optical sensing system 102 to generate a sensing result. The function and operation of each of these components is described below.

The optical sensing system 102 can implement DAS based on, for example, transmitting an optical signal, receiving a backscattered optical signal corresponding to the optical signal, and processing the backscattered optical signal to generate a sensing result. In some cases, the optical sensing system 102 can be a fiber interrogator. As illustrated, the optical sensing system 102 can include processor(s) 104, a memory 106, an interface 108, and an optical transceiving circuit 110. While illustrated as provided by or included in the optical sensing system 102, parts of the illustrated components/functionality of the optical sensing system 102 can be separate or remote from the optical sensing system 102, or the optical sensing system 102 can itself be distributed across the network.

The optical sensing system 102, as illustrated, includes one or more processors 104. Although illustrated as a single processor 104 in FIG. 1, multiple processors can be used according to particular needs, desires, or particular implementations of the system 100. Each processor 104 can be a central processing unit (CPU), an application specific integrated circuit (ASIC), a field-programmable gate array (FPGA), or another suitable component. Generally, the processor 104 executes instructions and manipulates data to perform the operations of the optical sensing system 102. Specifically, the processor 104 executes the algorithms and operations described in the illustrated figures, as well as the various software modules and functionality, including the functionality for sending communications to and receiving transmissions from the 2D waveguide 120. Each processor 104 can have a single or multiple cores, with each core available to host and execute an individual processing thread. Further, the number of, types of, and particular processors 104 used to execute the operations described herein can be dynamically determined based on a number of requests, interactions, and operations associated with the optical sensing system 102.

The interface 108 of the optical sensing system 102 is used by the optical sensing system 102 for communicating with other systems in a distributed environment—including within the environment 100—connected to the network 140. Generally, the interface 108 comprises logic encoded in software and/or hardware in a suitable combination and operable to communicate with the network 140 and other components. More specifically, the interface 108 can comprise software supporting one or more communication protocols associated with communications such that the network 140 and/or interface's hardware is operable to communicate physical signals within and outside of the illustrated system 100.

As illustrated, the optical sensing system 102 can also include memory 106, which can represent a single memory or multiple memories. The memory 106 can include any memory or database module and can take the form of volatile or non-volatile memory including, without limitation, magnetic media, optical media, random access memory (RAM), read-only memory (ROM), removable media, or any other suitable local or remote memory component. The memory 106 can store various objects or data associated with the optical sensing system 102, including any parameters, variables, algorithms, instructions, rules, constraints, or references thereto. While illustrated within the optical sensing system 102, memory 106 or any portion thereof, including some or all of the particular illustrated components, can be located remote from the optical sensing system 102 in some instances, including as a cloud application or repository, or as a separate cloud application or repository when the optical sensing system 102 itself is a cloud-based system.

As illustrated, the optical sensing system 102 can include an optical transceiving circuit 110. The optical transceiving circuit 110 can convert electrical signals to optical signals for transmission over optical medium (e.g., the waveguide 124) and convert optical signals back into electrical signals for processing by electronic devices.

As noted, the 2D waveguide 120 can be fabricated by ingraining a 1D linear waveguide 124 in a 2D substrate 122. Although illustrated as a snake-pattern in FIG. 1, the waveguide 124 can be arranged in other patterns, such as grid pattern, spiral pattern, etc., or any other desired layout. In some cases, the 2D substrate 122 can be a water-permeable membrane or a waterproof plastic layer.

In some examples, the 2D waveguide 120 can be fabricated based on one or more of the following methods. In some implementations, the waveguide 124 can be a fiber-optic cable, and the fiber-optic cable can be bonded to the 2D substrate 122 using a machine. This process can involve using a computer-controlled machine to lay out the fiber-optic cable on the 2D substrate 122 and attach (e.g., glue or otherwise adhere) the fiber-optic cable as it is laid out. In some implementations, the waveguide 124 can be printed on the 2D substrate 122 using a 3D printer. For example, the waveguide 124 can be printed (e.g., etched) on the 2D substrate 122 using the 3D printer, and then another 2D substrate can be laminated on the 2D substrate 122 that has the waveguide 124 formed on it. In some implementations, the waveguide 124 can be generated on the 2D substrate 122 using a silicon photonics fabrication method. In some implementations, the 2D waveguide 120 can be fabricated using a planar light wave circuit (PLC) fabrication method and/or a lithium niobate on insulator (LNOI) method. In some implementations, a small-scale version of the 2D waveguide 120 can be manufactured with 3D printing.

As illustrated, the waveguide 124 can include one or more reflectors (e.g., random imperfections) 134. The one or more reflectors 134 can cause a small amount of backscattering and/or forward scattering, and can reduce the signal in one or both directions. In some cases, the waveguide 124 can be engineered to purposefully include one or more reflectors 134 at specific location(s).

Network 140 facilitates wireless or wireline communications between the components of the system 100, as well as with any other local or remote computers, such as additional mobile devices, clients, servers, or other devices communicably coupled to network 140, including those not illustrated in FIG. 1. In the illustrated environment, the network 140 is depicted as a single network, but can be comprised of more than one network without departing from the scope of this disclosure, so long as at least a portion of the network 140 can facilitate communications between senders and recipients. In some instances, one or more of the illustrated components can be included within or deployed to network 140 or a portion thereof as one or more cloud-based services or operations. The network 140 can be all or a portion of an enterprise or secured network, while in another instance, at least a portion of the network 140 can represent a connection to the Internet. In some instances, a portion of the network 140 can be a virtual private network (VPN). Further, all or a portion of the network 140 can comprise either a wireline or wireless link. Example wireless links can include 802.11a/b/g/n/ac, 802.20, WiMax, LTE, and/or any other appropriate wireless link. In other words, the network 140 encompasses any internal or external network, networks, sub-network, or combination thereof operable to facilitate communications between various computing components inside and outside the illustrated system 100. The network 140 can communicate, for example, Internet Protocol (IP) packets, Frame Relay frames, Asynchronous Transfer Mode (ATM) cells, voice, video, data, and other suitable information between network addresses. The network 140 can also include one or more local area networks (LANs), radio access networks (RANs), metropolitan area networks (MANs), wide area networks (WANs), all or a portion of the Internet, and/or any other communication system or systems at one or more locations.

While portions of the elements illustrated in FIG. 1 are shown as individual components that implement the various features and functionality through various objects, methods, or other processes, the software can instead include a number of sub-modules, third-party services, components, libraries, and such, as appropriate. Conversely, the features and functionality of various components can be combined into single components as appropriate.

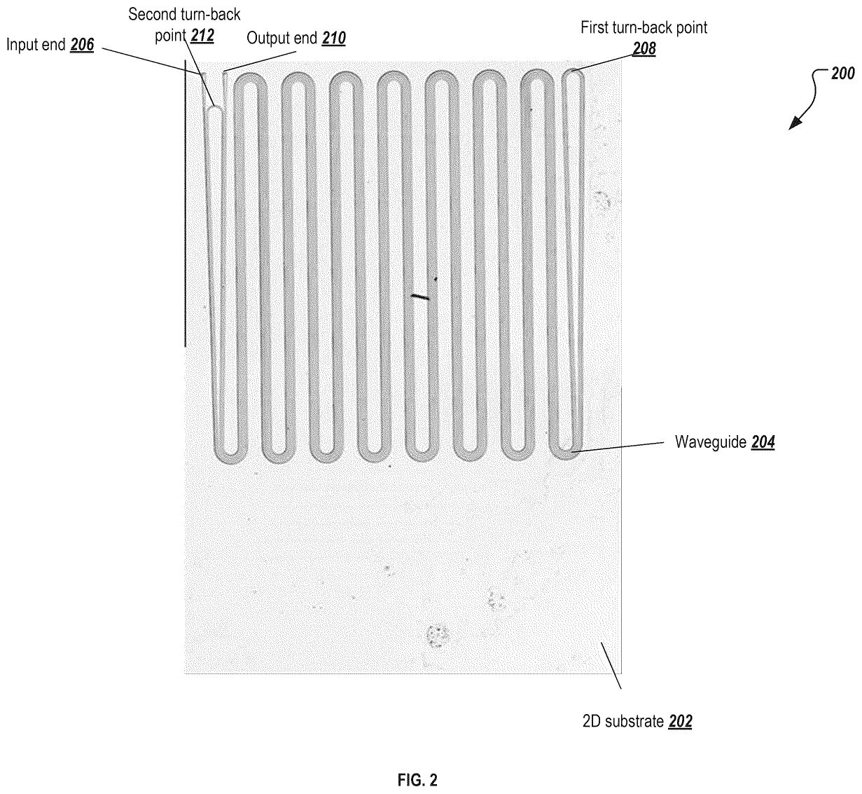

FIG. 2 depicts an example 2D waveguide 200. In some cases, the 2D waveguide 200 is an example embodiment of the 2D waveguide 120 as described with respect to FIG. 1. In some implementations, the 2D waveguide 200 is implemented with nanophotonic waveguide(s). As depicted, the 2D waveguide 200 includes a 2D substrate 202 and a waveguide 204. The 2D substrate 202 can be operationally and/or structurally similar to the 2D substrate 122, and the details of the 2D substrate 202 are omitted here for brevity.

As illustrated, the waveguide 204 include a plurality of parallel nested paths. The quantity of the plurality of parallel nested paths is not limited to that shown in FIG. 2 and can be any suitable quantity. In some implementations, the plurality of parallel nested paths can be formed using one fiber-optic cable. For example, a fiber-optic cable can be laid out from an input end (e.g., the input end 206) to a first turn-back point (e.g., the first turn-back point 208) following a particular pattern (e.g., snake-like pattern as depicted in FIG. 2). The fiber-optic cable can be bent at the first turn-back point and laid out from the first turn-back point to the input end following the particular pattern. By doing so, two parallel nested paths can be formed. This process can be repeated to form more parallel nested paths. For example, if a third parallel nested path is needed, the fiber-optic cable can be bent at a second turn-back point (e.g., the second turn-back point 212) close to the input end, and then laid out from the second turn-back point to the first turn-back point or an output end (e.g., the output end 210) following the particular pattern. In some cases, the fiber-optical cable can exit the 2D waveguide 204 via the output end 210. The multiple parallel nested paths can increase packing density compared to a non-nested single-path design. In some cases, a 2D waveguide based on the multiple parallel nested paths can be three to four times smaller than that based on the non-nested single-path design.

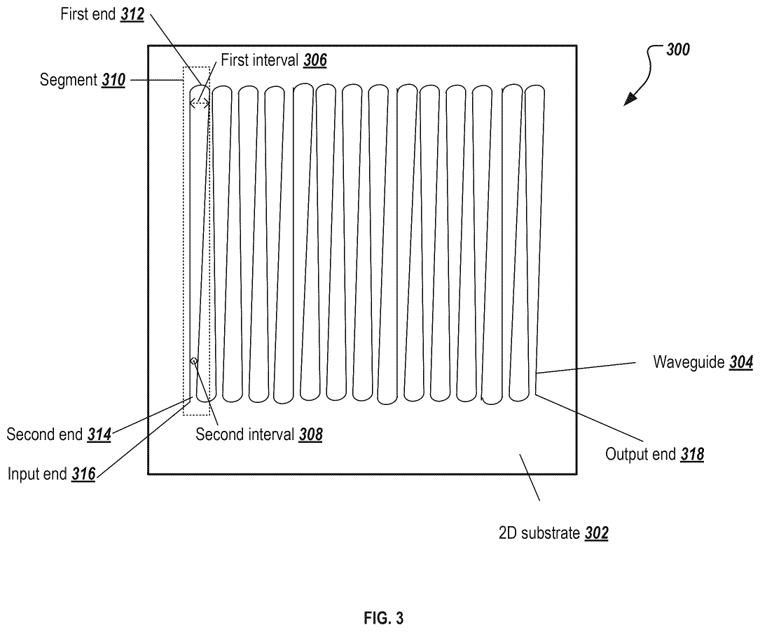

FIG. 3 depicts another example 2D waveguide 300. In some cases, the 2D waveguide 300 is an example embodiment of the 2D waveguide 120 as described with respect to FIG. 1. In some implementations, the 2D waveguide 300 is implemented with nanophotonic waveguide(s). As depicted, the 2D waveguide 300 includes a 2D substrate 302 and a waveguide 304 which has an input end 316 and an output end 318. The 2D substrate 302 can be operationally and/or structurally similar to the 2D substrate 122, and the details of the 2D substrate 302 are omitted here for brevity.

As illustrated, the waveguide 304 can have a slanted design. Specifically, the waveguide 304 includes a plurality of segments, where each segment is similar to segment 310. The segment 310 has a first end 312, where the waveguide 304 bends, and a second end 314 opposite to the first end 312. The first interval 306 at the first end 312 is wider than the second interval 308 at the second end 314. The slanted design enables to pack a longer waveguide than a non-slanted design (e.g., the waveguide 204 shown in FIG. 2), and therefore can increase packing density compared to a non-slanted design. In some implementations, both of the features of multiple parallel nested paths as described with respect to FIG. 2 and the slanted design as described with respect to FIG. 3 can be implemented in one 2D waveguide to increase packing density.

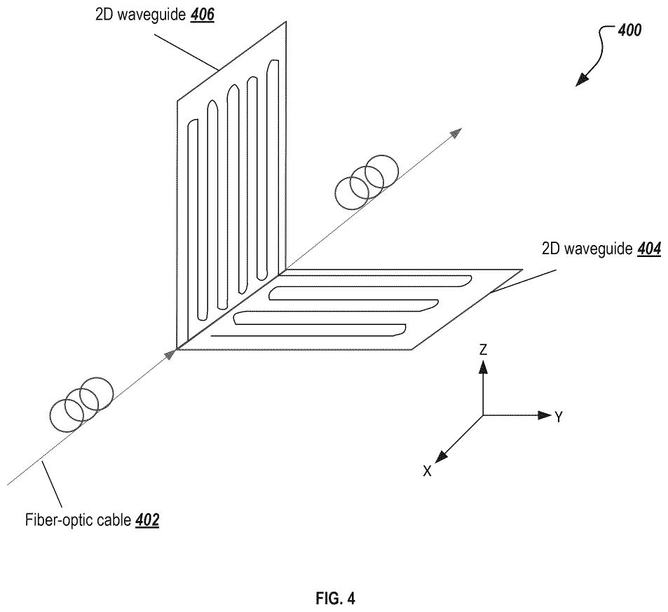

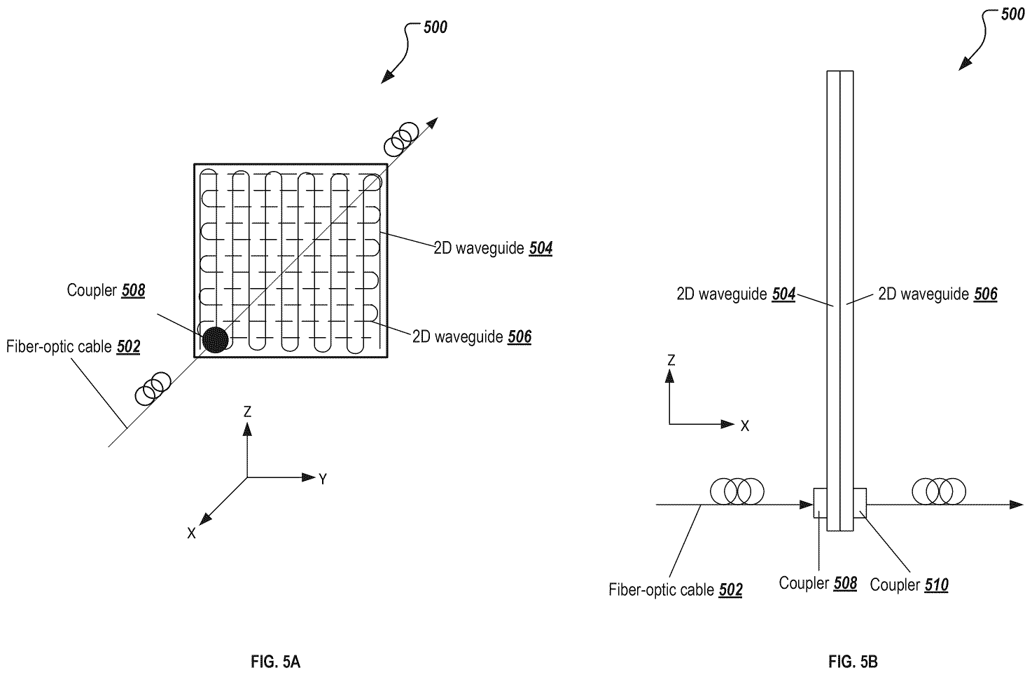

In some implementations, the 2D waveguide can be combined with other component(s) to yield a 3-axis sensing mode. FIG. 4 and FIG. 5 depict two example systems for using 2D waveguides to yield a 3-axis sensing mode.

FIG. 4 depicts an example system 400 for using 2D waveguides to yield a 3-axis sensing mode. The system 400 includes a fiber-optic cable 402, a 2D waveguide 404, and a 2D waveguide 406. In some implementations, the 2D waveguide 404 and/or the 2D waveguide 406 is operationally and/or structurally similar to any of the 2D waveguides described with respect to FIGS. 1-3.

As illustrated, the fiber-optic cable 402 extends along the X axis. The 2D waveguide 404 is on a plane of the X and Y axes. The 2D waveguide 406 is on a plane of the X and Z axes, and the 2D waveguide 406 is perpendicular to the 2D waveguide 404. The fiber-optic cable 402 can sense strain along the X axis. The optical signal of the fiber-optic cable 402 can be fed into the 2D waveguide 406 which can sense strain along the Z axis. The optical signal of the 2D waveguide 406 can then be fed into the 2D waveguide 404 which can sense strain along the Y axis. Accordingly, the system 400 can sense strains in a three-dimensional space.

FIG. 5A and FIG. 5B depict another example system 500 for using 2D waveguides to yield a 3-axis sensing mode. FIG. 5A depicts the system 500 in a three-dimensional space, whereas FIG. 5B depicts a side view of the system 500 in the plane of X and Z axes. The system 500 includes a fiber-optic cable 502, a 2D waveguide 504, a 2D waveguide 506, a coupler 508, and a coupler 510. In some implementations, the 2D waveguide 504 and/or the 2D waveguide 506 is operationally and/or structurally similar to any of the 2D waveguides described with respect to FIGS. 1-3. Each of the couplers 508 and 510 can provide an interface between an optical sensing system (not shown) and a 2D waveguide. In some implementations, an optical signal cannot be directly transmitted into a planar waveguide (e.g., the 2D waveguide 504 and/or 506), so a coupler can be used to transmit light from a fiber-optic cable to the planar waveguide. In some instances, each of the couplers 508 and 510 can be, for example, an edge coupler, Bragg coupler, etc.

As illustrated, the fiber-optic cable 502 extends along the X axis. The 2D waveguide 504 and the 2D waveguide 506 are parallel—both are on the plane of the Y and Z axes—and overlapped with each other. However, the 2D waveguide 506 is rotated 90 degrees compared to the 2D waveguide 504. The fiber-optic cable 502 can sense strain along the X axis. The optical signal of the fiber-optic cable 502 can be fed into, via the coupler 508, the 2D waveguide 504 which can sense strain along the Z axis. The optical signal of the 2D waveguide 504 can then be fed into the 2D waveguide 506 which can sense strain along the Y axis. The optical signal can then exit the 2D waveguide 506 and fed into a fiber-optic cable via the coupler 510. Accordingly, the system 500 can sense strains in a three-dimensional space.

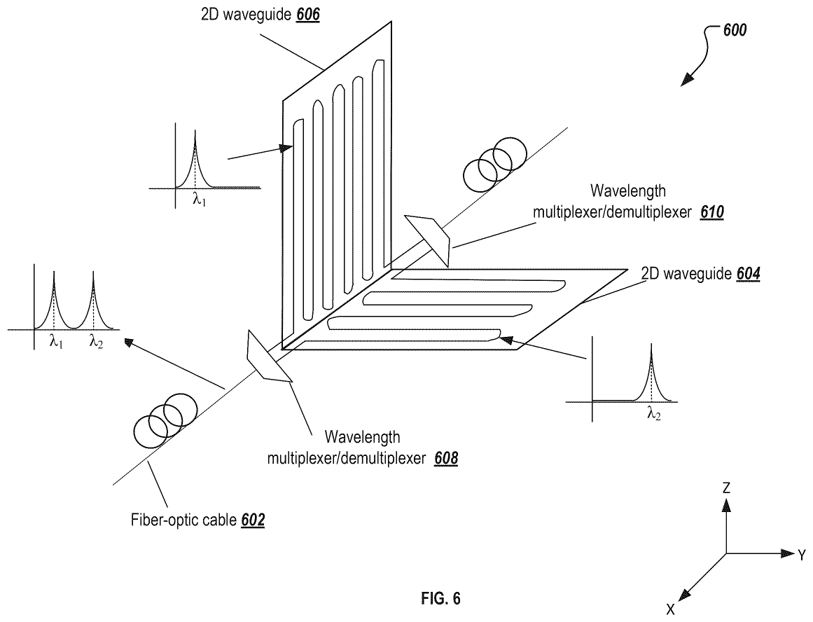

FIG. 6 depicts yet another example system 600 for using 2D waveguides to yield a 3-axis sensing mode. The system 600 includes a fiber-optic cable 602, a 2D waveguide 604, a 2D waveguide 606, a wavelength multiplexer/demultiplexer 608, and a wavelength multiplexer/demultiplexer 610. In some implementations, the 2D waveguide 604 and/or the 2D waveguide 606 is operationally and/or structurally similar to any of the 2D waveguides described with respect to FIGS. 1-3. In some implementations, each of the wavelength multiplexers/demultiplexers 608 and 610 can be used to multiplex different wavelengths into a composite optical signal to be transmitted over an optical fiber and/or demultiplex the composite optical signal into separate wavelengths. In some cases, each of the wavelength multiplexers/demultiplexers 608 and 610 can be a passive device, such as a passive wavelength division multiplexing (WDM) device. In some cases, each of the wavelength multiplexers/demultiplexers 608 and 610 can be an active device, such as an active optical add-drop multiplexer (OADM). In some implementations, the wavelength multiplexer/demultiplexer 608 and the wavelength multiplexer/demultiplexer 610 can be different. For example, one of the wavelength multiplexer/demultiplexer 608 and the wavelength multiplexer/demultiplexer 610 can be a passive device, whereas the other wavelength multiplexer/demultiplexer can be an active device.

As illustrated, the fiber-optic cable 602 extends along the X axis. The 2D waveguide 604 is on a plane of the X and Y axes. The 2D waveguide 606 is on a plane of the X and Z axes, and the 2D waveguide 606 is perpendicular to the 2D waveguide 604. The fiber-optic cable 602 can sense strain along the X axis. A composite optical signal can be transmitted over the fiber-optic cable 602, where the composite optical signal includes an optical signal at wavelength λ₁ and an optical signal at wavelength λ₂. The wavelength multiplexer/demultiplexer 608 (or the wavelength multiplexer/demultiplexer 610) can demultiplex the composite optical signal into two single-wavelength optical signals. The optical signal at wavelength λ₁ can be fed into the 2D waveguide 606 which can sense strain along the Z axis. The optical signal at wavelength λ₂ can be fed into the 2D waveguide 604 which can sense strain along the Y axis. The wavelength multiplexer/demultiplexer 610 (or the wavelength multiplexer/demultiplexer 608) can then multiplex the two single-wavelength optical signals into a composite optical signal to be transmitted on the fiber-optic cable 602 again. Accordingly, the system 600 can sense strains in a three-dimensional space.

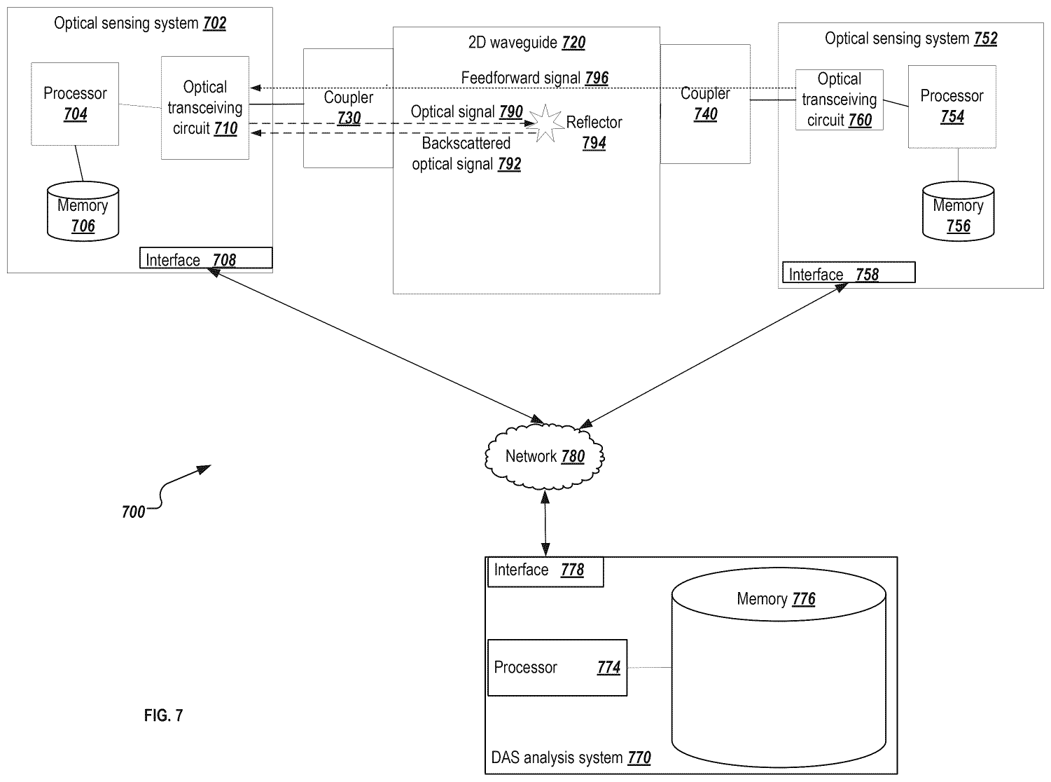

FIG. 7 is a block diagram of a system 700 for implementing DAS using 2D waveguides. As shown in FIG. 7, the example system 700 includes an optical sensing system 702, a coupler 730, a 2D waveguide 720, a coupler 740, an optical sensing system 752, a network 780, and a DAS analysis system 770. In some cases, the system 700 can use multiple optical sensing systems, such as optical sensing system 702 and optical sensing system 752, to achieve a more accurate sensing result based on, for example, feedforward signals sent from each other.

In some implementations, the optical sensing system 702 can transmit an optical signal 790 into the 2D waveguide 720 via the coupler 730. The optical signal 790 can travel in the 2D waveguide 720 and can be backscattered by one or more reflectors 794 in the 2D waveguide 720 to generate a backscattered optical signal 792. The backscattered optical signal 792 can be received and analyzed by the optical sensing system 702 to generate a sensing result. In some cases, the optical sensing system 752 can transmit a feedforward signal 796 to the optical sensing system 702 via the coupler 740, the 2D waveguide 720, and the coupler 730. In some instances, the feedforward signal 796 can be used to generate the sensing result. In some implementations, the optical sensing system 702 can offload at least a part of the computation of the sensing result to the DAS analysis system 770. The function and operation of each of these components is described below.

Similar to the optical sensing system 102 described in FIG. 1, the optical sensing system 702 can include processor(s) 704, a memory 706, an interface 708, and an optical transceiving circuit 710. Similarly, the optical sensing system 752 can include processor(s) 754, a memory 756, an interface 758, and an optical transceiving circuit 760. In some cases, the optical sensing system 702 and the optical sensing system 752 can be operationally and/or structurally similar to the optical sensing system 102, and the details of the optical sensing system 702 and the optical sensing system 752 are omitted here for brevity. Although illustrated as two optical sensing systems in FIG. 7, more than two optical sensing systems can be used according to particular needs, desires, or particular implementations of the system 700. For example, in some cases, optical sensing systems can be deployed along one or both horizontal edges and/or one or both vertical edges of the 2D waveguide 720. In some cases, the optical sensing systems can send direct signals to each other to coordinate the sensing (more details are described below).

The coupler 730 can provide an interface between the optical sensing system 702 and the 2D waveguide 720. In some implementations, an optical signal cannot be directly transmitted into a planar waveguide (e.g., the 2D waveguide 720), so a coupler can be used to transmit light from a fiber-optic cable to the planar waveguide. In some cases, the optical sensing system 702 can be connected to the coupler 730 via a fiber-optic cable. The optical sensing system 702 can transmit an optical signal (e.g., the optical signal 790) into the fiber-optic cable, and the coupler 730 can feed the optical signal from the fiber-optic cable to the 2D waveguide feed 720. The coupler 740 can be operationally and/or structurally similar to the coupler 730, and the details of the coupler 740 are omitted here for brevity.

The 2D waveguide 720 can be used to detect and measure acoustic events over a 2D surface. In some cases, the 2D waveguide 720 can be a piece of flexible glass that implements a 2D resonator. For example, the 2D waveguide 720 can be fabricated by creating a thin, flat sheet of material with a high refractive index, such as silicon, and etching a pattern of resonant cavities into the material. These cavities can be designed to support resonant modes that can trap light within the material and allow it to circulate around the cavities in a closed loop. By carefully designing the shape and size of the cavities, a 2D resonator can be created to support multiple resonant modes with different frequencies and field patterns. When an optical signal (e.g., the optical signal 790) is transmitted into the 2D waveguide 720, the optical signal can excite one or more of these resonant modes, which can be detected as changes in the backscattered optical signal (e.g., the backscattered optical signal 792). In some implementations, the 2D waveguide 720 can be fabricated using a planar light wave circuit (PLC) fabrication method and/or a lithium niobate on insulator (LNOI) method.

In some cases, the optical sensing system 702 can offload at least a part of the computation of the sensing result to the DAS analysis system 770. As illustrated, the DAS analysis system 770 includes or is associated with interface 778 (which can be operationally and/or structurally similar to interface 108), processor(s) 774 (which can be operationally and/or structurally similar to processor 104, and which can execute the functionality of the DAS analysis system 770), and memory 776 (which can be operationally and/or structurally similar to memory 106). While illustrated as provided by or included in the DAS analysis system 770, parts of the illustrated components/functionality of the DAS analysis system 770 can be separate or remote from the DAS analysis system 770, or the DAS analysis system 770 can itself be distributed across the network 780.

As used in the present disclosure, the term “computer” is intended to encompass any suitable processing device. For example, the DAS analysis system 770 can be any computer or processing devices such as, for example, a blade server, general-purpose personal computer (PC), Mac®, workstation, UNIX-based workstation, or any other suitable device. Moreover, although FIG. 7 illustrates a single DAS analysis system 770, the DAS analysis system 770 can be implemented using a single system or more than those illustrated, as well as computers other than servers, including a server pool. In other words, the present disclosure contemplates computers other than general-purpose computers, as well as computers without conventional operating systems.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including, e.g., C, C++, JavaScript, Java™, Visual Basic, assembler, Perl®, any suitable version of 4GL, as well as others.

In some cases, the network 780 can be operationally and/or structurally similar to the network 140, and the details of the network 780 are omitted here for brevity. While portions of the elements illustrated in FIG. 7 are shown as individual components that implement the various features and functionality through various objects, methods, or other processes, the software can instead include a number of sub-modules, third-party services, components, libraries, and such, as appropriate. Conversely, the features and functionality of various components can be combined into single components as appropriate.

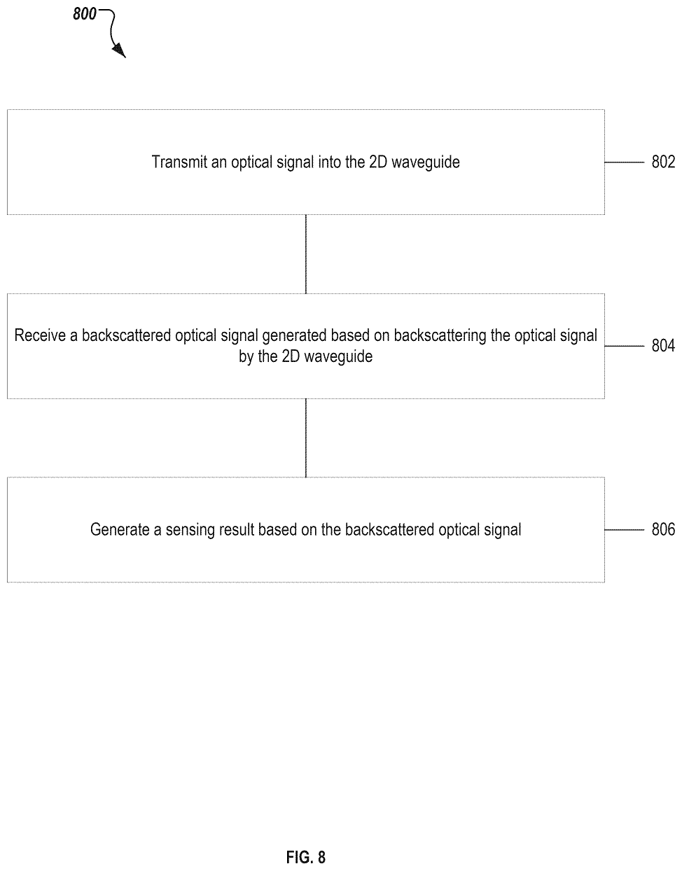

FIG. 8 is a flow diagram of an example method 800 for implementing DAS using 2D waveguides. It should be understood that method 800 can be performed, for example, by any suitable system, environment, software, and hardware, or a combination of systems, environments, software, and hardware as appropriate. In some instances, method 800 can be performed by a system including one or more components of the system 100 described in FIG. 1, as well as other components or functionality described in other portions of this description. In some instances, method 800 can be performed by a system including one or more components of the system 700 described in FIG. 7, as well as other components or functionality described in other portions of this description. Any suitable system(s), architecture(s), or application(s) can be used to perform the illustrated operations.

At 802, an optical sensing system (e.g., the optical sensing system 102 or the optical sensing system 702) can transmit an optical signal (e.g., a laser pulse) used for DAS to the 2D waveguide (e.g., the 2D waveguide 120), or to a coupler (e.g., the coupler 730) which can feed the optical signal to the 2D waveguide (e.g., the 2D waveguide 720). In some implementations, the optical sensing system can transmit the optical signal periodically (e.g., once every minute, once every hour etc.). In some implementations, the optical sensing system can transmit the optical signal upon the occurrence of a particular event (e.g., receiving an instruction for sending a laser pulse).

In some implementations, as depicted in FIG. 7, the optical sensing system can transmit the optical signal to a coupler (e.g., the coupler 730) via a fiber-optic cable. The coupler can feed the optical signal from the fiber-optic cable to a 2D waveguide (e.g., the 2D waveguide 720).

At 804, the optical sensing system can receive a backscattered optical signal generated based on backscattering the optical signal by the 2D waveguide. As the optical signal travels into the 2D waveguide, a small part of the optical signal can be backscattered to the optical sensing system due to the reflections and scattering produced by one or more reflectors existing inside the 2D waveguide. In some instances, as depicted in FIG. 7, the optical sensing system can receive the backscattered optical signal via a coupler (e.g., the coupler 730).

At 806, the optical sensing system and/or a DAS analysis system (e.g., the DAS analysis system 770) can generate a sensing result based on the backscattered optical signal. In some cases, the sensing result can indicate at least one of whether an acoustic event surrounding the 2D waveguide has occurred, an amplitude of the acoustic event (indicating a magnitude of the acoustic event), a location of the acoustic event, a distance of the acoustic event relative to the optical sensing system, or a spatial resolution of the distance of the acoustic event.

In some implementations, the optical sensing system can generate the sensing result based on the optical signal and its corresponding backscattered optical signal. For example, the optical sensing system can measure the phase difference between the optical signal and the backscattered optical signal to detect change(s) in the position(s) of the reflector(s), and identify acoustic event(s) based on these change(s) of position(s).

In some implementations, especially with respect to system 700, another optical sensing system (e.g., the optical sensing system 752) can transmit a feedforward optical signal to the optical sensing system 702 via the 2D waveguide 720. The optical sensing system and/or the DAS analysis system can generate the sensing result based on the backscattered optical signal and the feedforward optical signal.

In some cases, especially with respect to system 700, the optical sensing system(s) can receive a large amount of data (e.g., in the order of terabytes per hour) for generating the sensing result. As a result, in some cases, the optical sensing system(s) do not have sufficient computing and/or memory resources to process the large amount of data. Therefore, the optical sensing system(s) can offload at least a part of the computation of the sensing result to a DAS analysis system (e.g., the DAS analysis system 770), which can be equipped with a greater amount of computing and/or memory resources than an optical sensing system.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system for distributed acoustic sensing (DAS), comprising:
a two-dimensional (2D) waveguide, the 2D waveguide configured to backscatter optical signals; and
a first optical sensing system, configured to:
transmit a first optical signal into the 2D waveguide;
receive a backscattered optical signal generated based on backscattering the first optical signal by the 2D waveguide; and
generate a sensing result based on the backscattered optical signal.

2. The system of claim 1, wherein the 2D waveguide comprises a 2D substrate and a waveguide embedded in the 2D substrate.

3. The system of claim 2, wherein the waveguide comprises a plurality of parallel nested paths.

4. The system of claim 2, wherein the waveguide comprises a segment having a first end and a second end opposite to the first end, the waveguide bends at the first end, and a first interval at the first end is wider than a second interval at the second end.

5. The system of claim 2, wherein the 2D waveguide is fabricated based on at least one of:
bonding the waveguide to the 2D substrate using a machine;
printing the waveguide on the 2D substrate using a three-dimensional printer;
a planar light wave circuit (PLC) fabrication method; or
a lithium niobate on insulator (LNOI) method.

6. The system of claim 2, wherein the 2D substrate comprises a water-permeable membrane or a waterproof plastic layer.

7. The system of claim 1, wherein the system comprises a fiber-optic cable and an additional 2D waveguide perpendicular to the 2D waveguide, and wherein the fiber-optic cable is used to sense strains on a first axis, the 2D waveguide is used to sense strains on a second axis perpendicular to the first axis, and the additional 2D waveguide is used to sense strains on a third axis perpendicular to the first axis and the second axis.

8. The system of claim 1, wherein the system comprises a fiber-optic cable and an additional 2D waveguide overlapped with the 2D waveguide, and wherein the fiber-optic cable is used to sense strains on a first axis, the 2D waveguide is used to sense strains on a second axis perpendicular to the first axis, and the additional 2D waveguide is used to sense strains on a third axis perpendicular to the first axis and the second axis.

9. The system of claim 1, wherein the first optical sensing system is connected to a fiber-optic cable, and the system comprises a coupler feeding the first optical signal from the fiber-optic cable to the 2D waveguide.

10. The system of claim 1, wherein the system comprises a second optical sensing system, the second optical sensing system transmits a second optical signal into the 2D waveguide, and the sensing result is generated based on the backscattered optical signal and the second optical signal.

11. The system of claim 1, wherein the sensing result indicates at least one of whether an acoustic event has occurred, an amplitude of the acoustic event, a location of the acoustic event, a distance of the acoustic event relative to the first optical sensing system, or a spatial resolution of the distance of the acoustic event.

12. A method comprising:
transmitting, by a first optical sensing system, a first optical signal into a two-dimensional (2D) waveguide, the 2D waveguide configured to backscatter optical signals;
receiving, by the first optical sensing system, a backscattered optical signal generated based on backscattering the first optical signal by the 2D waveguide; and
generating, by the first optical sensing system, a sensing result based on the backscattered optical signal.

13. The method of claim 12, wherein the 2D waveguide comprises a 2D substrate and a waveguide embedded in the 2D substrate.

14. The method of claim 13, wherein the waveguide comprises a plurality of parallel nested paths.

15. The method of claim 13, wherein the waveguide comprises a segment having a first end and a second end opposite to the first end, the waveguide bends at the first end, and a first interval at the first end is wider than a second interval at the second end.

16. The method of claim 13, wherein the 2D waveguide is fabricated based on at least one of:
bonding the waveguide to the 2D substrate using a machine;
printing the waveguide on the 2D substrate using a three-dimensional printer;
a planar light wave circuit (PLC) fabrication method; or
a lithium niobate on insulator (LNOI) method.

17. The method of claim 13, wherein the 2D substrate comprises a water-permeable membrane or a waterproof plastic layer.

18. A non-transitory, computer-readable medium storing computer-readable instructions, that upon execution by at least one hardware processor, cause performance of operations, comprising:
transmitting, by a first optical sensing system, a first optical signal into a two-dimensional (2D) waveguide, the 2D waveguide configured to backscatter optical signals;
receiving, by the first optical sensing system, a backscattered optical signal generated based on backscattering the first optical signal by the 2D waveguide; and
generating, by the first optical sensing system, a sensing result based on the backscattered optical signal.

19. The non-transitory, computer-readable medium of claim 18, wherein the 2D waveguide comprises a 2D substrate and a waveguide embedded in the 2D substrate.

20. The non-transitory, computer-readable medium of claim 19, wherein the waveguide comprises a plurality of parallel nested paths.
